(19) United States
(12) Patent Application Publication
(10) Pub. No.: US 2011/0039077 A1
(43) Pub. Date: Feb. 17, 2011

(54) Stain-Resistant Overcoat

(76) Inventor: Bruce M. Klemann, Shorewood, WI (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/539,909

(22) Filed: Aug. 12, 2009

(51) Int. Cl. B32B 3/10; C08L 27/12; C08K 5/01; B05D 1/36; C08K 5/103; C08K 5/06

(52) U.S. Cl. 428/195.1; 525/55; 524/81; 427/407.1; 524/545; 524/317; 524/377

(57) ABSTRACT

Stain-resistant, overcoat formulations for porous print media and having a viscosity of less than 20 cP comprise at least one (a) low-surface-energy fluoropolymer, and (b) film-forming binder resin.

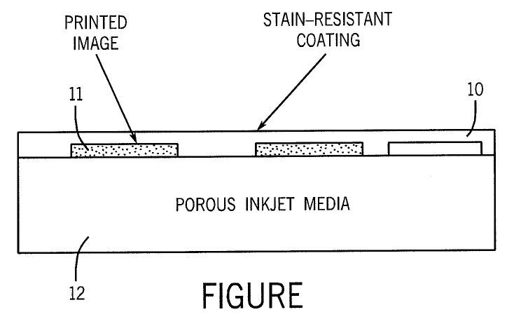

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention relates to print recording media. In one aspect, the invention relates to a print recording media overcoat while in another aspect, the invention relates to labels and signs that incorporate a print recording media with an overcoat.

### BACKGROUND OF THE INVENTION

Print media for aqueous inkjet inks is porous so that it can absorb inks rapidly and dry quickly leaving it dry to the touch so that it may be handled immediately. After printing, if not sealed the media will be stained if it absorbs colored liquids or entrains small colored particles. The source of these particles could be beverages, industrial chemicals, powders or airborne particulates. Printed media that can resist such stains is of interest to the print market.

### BRIEF SUMMARY OF THE INVENTION

In one embodiment of the invention, a stain-resistant, overcoat formulation for porous print media and having a viscosity of less than 20 centipoise (cP), the overcoat formulation comprising at least one (a) low-surface-energy fluoropolymer, and (b) film-forming binder resin. The overcoat may also comprise a coalescent that improves the film-forming capability of the fluoropolymer and binder resin. The fluoropolymer imparts to the overcoat a resistance to the spreading and absorption of fluids. The viscosity of the overcoat formulation is sufficiently low so as to allow the application of the overcoat to the print media with an inkjet printhead. This, in turn, allows for a low-cost and highly-controlled deposition of the coating. The coating also exhibits good solvent resistance and weathering performance so that it does not compromise the solvent or weather resistance of label or graphics media.

### BRIEF DESCRIPTION OF THE DRAWING

The FIGURE is a schematic of a stain-resistant overcoat on a print media.

### DETAILED DESCRIPTION OF THE PREFERRED EMBODIMENT

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, layer thickness, component weight ratios and various process ranges.

“Overcoat”, “overcoat layer” and similar terms mean the layer that is over and in direct contact with the image that is carried on the print media.

The overcoat layer of this invention is illustrated in the FIGURE in which overcoat 10 is printed onto or otherwise adhered directly to image 11 which, in turn, is printed or otherwise adhered directly to print media 12. To the extent that gaps exist between the various components of the image, overcoat 10 is in direct contact with print media 12. In a preferred embodiment of the invention, overcoat 10 completely covers and seals the surface of the image and any exposed surface of the print media.

Fluoropolymer Resin

The low surface energy of fluoropolymers makes it difficult for liquids to spread on the surface of the coating and to penetrate into the inkjet media. This property greatly enhances the stain-resistance. If the formulation is to be applied to the inkjet media with a low-cost piezoelectric or thermal inkjet printhead, the fluoropolymer resin is dispersed in an aqueous medium that is compatible with the materials of the printhead and ink conduits. For application with industrial piezoelectric inkjet printheads or roll-coaters, fluoropolymer solutions or dispersions in organic solvents are suitable.

Many types of fluoropolymers can be used. These include, without limitation, poly(tetrafluoroethylene), poly(vinyl fluoride), poly(vinylidene fluoride), poly(hexafluoro-propylene), fluorinated ethylene-propylene copolymers, copolymers of hexafluoropropylene and vinyl fluoride, terpolymers of hexafluoropropylene-vinyl fluoride-tetrafluoroethylene, polymers of mixed fluoro-chloro ethylenes and propylenes, copolymers of tetrafluoroethylene and vinylidene fluoride, and polymers of perfluoroalkyoxy resins. Also useful are copolymers and terpolymers of any of these fluoropolymers with one or more vinyl ether; acrylic; methacrylic; urethane; polyester; vinyl acetate or vinyl alcohol homopolymer, copolymer, terpolymer, etc. or a derivative of the same; ethylene; propylene; thermoplastic polymers of ethylene and propylene; styrenic resins; polyamides; vinyl chloride; and vinylidene chloride.

Preferred fluoropolymer resins include LUMIFLON fluoroethylene-vinyl ether copolymers available from Asahi Glass. These resins typically contain 25-35% by weight of fluorine (Seiji Munekata, Progress in Organic Coatings 16, 1998, 113-134.). Particularly preferred are aqueous dispersions of fluoroethylene-vinyl ether copolymers such as LUMIFLON FE-4300, LUMIFLON FE-4400, and LUMIFLON FD-916. Also preferred are dispersions made starting with LUMIFLON LF-710F powder. All of these fluoropolymers are particularly useful in stain-resistant coating formulations that are to be applied with low-cost, piezoelectric or thermal inkjet printheads.

The fluoropolymer typically comprises at least 12, more typically at least 15 and even more typically at least 20, weight percent of the overcoat formulation sans diluent and any other component of the overcoat formulation that evaporates or is other wise lost in the time period measured from the application of the overcoat formulation to the print media to the drying of the overcoat on the print media. Typically, the fluoropolymer does not exceed 90, more typically it does not exceed 80 and even more typically it does not exceed 75, weight percent of this overcoat formulation.

### Film-Forming Binder Resins

In order to protect porous inkjet media from staining, the stain-resistant formulation contains a continuous film that seals the pores of the inkjet media. The fluoropolymer itself may serve this role, but it is generally desirable to add one or more film-forming resins to increase the strength and protective-effect of the applied coating. These film-forming resins may also be chosen so as to increase the solvent resistance, abrasion resistance or weathering performance of the coating.

The film-forming binder resins can comprise any film-forming polymer. Examples of useful binders include but are not limited to acrylics and methacrylics, polyurethanes, polyesters, polycarbonates, poly(vinyl ethers), poly(vinyl acetate), poly(vinyl alcohol), poly(vinyl butyral), copolymers of vinyl acetate and vinyl alcohol, thermoplastic polymers of ethylene and/or propylene, poly(vinyl chloride), polyamides, polyimides, styrenic resins, phenoxies, cellulose acetate butyrate polymers, cellulose acetate propionate polymers, ionomers, and any blends or copolymers of two or more of these.

Preferred film-forming binder resins include NEOCRYL acrylic resin emulsion and NEOREZ polyurethane resin dispersions available from DSM NeoResins. Examples include NEOCRYL A-612, NEOCRYL A-634, NEOCRYL A-1049, NEOCRYL A-6092, NEOCRYL XK-101, NEOREZ R-966, NEOREZ R-967, and NEOREZ R-972. Other preferred film-forming acrylics include JONCRYL 74, JONCRYL 98, and JONCRYL 617-A emulsions from BASF, and NEOCAR 820, UCAR 625, and UCAR 627 emulsions from The Dow Chemical Company. Other preferred polyurethane dispersions include WITCOBOND A-100, WITCOBOND W-213, and WITCOBOND W-240 from Chemtura, Inc. Particularly preferred film-forming binder resins include NEOCRYL A-634, JONCRYL 98, WITCOBOND W-240, and NEOCAR 820.

The film-forming binder resin typically comprises at least 10, more typically at least 15 and even more typically at least 20, weight percent of the overcoat formulation sans diluent and any other component of the overcoat formulation that evaporates or is other wise lost in the time period measured from the application of the overcoat formulation to the print media to the drying of the overcoat on the print media. Typically, the film-forming binder resin does not exceed 80, more typically it does not exceed 75 and even more typically it does not exceed 70, weight percent of this overcoat formulation.

The fluoropolymer and film-forming binder resin are typically present in the overcoat formulation at a fluoropolymer to binder resin weight ratio of 0.25:1 to 9:1, more typically of 0.33:1 to 5:1, and even more typically of 0.42:1 to 4:1.

### Coalescents

For dispersions or emulsions of polymers, the minimum film-forming temperature (MFFT) is defined as the minimum temperature at which a coherent, continuous film forms when the dispersion or emulsion is dried. When the MFFT is above ambient conditions, the dispersion or emulsion is typically heated during the drying process in order to form a coherent film. Alternatively, the MFFT may be reduced by the addition of a solvent that acts as an internal plasticizer for the polymer, termed a “coalescent”. Most glycol ethers and glycol ether acetates are suitable coalescents. Examples of these coalescents include, but are not limited to, propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, propylene glycol diacetate, dipropylene glycol dimethyl ether, diethylene glycol ethyl ether, diethylene glycol methyl ether, diethylene glycol n-butyl ether, diethylene glycol n-hexyl ether, diethylene glycol n-butyl ether acetate, ethylene glycol propyl ether, ethylene glycol n-butyl ether, ethylene glycol hexyl ether, ethylene glycol n-butyl ether acetate, triethylene glycol methyl ether, triethylene glycol ethyl ether, triethylene glycol n-butyl ether, ethylene glycol phenyl ether and ethylene glycol phenyl ether. Examples of organic solvents that are suitable as coalescents are propylene glycol, Texanol (2,2,4-trimethyl 1,3-pentanediol monoisobutyrate) and N-methyl pyrrolidone. Preferred coalescents include Texanol, dipropylene glycol propyl ether, dipropylene glycol n-butyl ether, dipropylene glycol dimethyl ether, tripropylene glycol n-butyl ether, N-methyl pyrrolidone, and propylene glycol. Most preferred coalescents include tripropylene glycol n-butyl ether, N-methyl pyrrolidone and Texanol.

The coalescent, if present and not also acting as a diluent for the overcoat formulation, typically comprises at least 3, more typically at least 5 and even more typically at least 10, weight percent of the overcoat formulation sans diluent and any other component of the overcoat formulation that evaporates or is other wise lost in the time period measured from the application of the overcoat formulation to the print media to the drying of the overcoat on the print media. Typically, the coalescent if not also acting as a diluent, does not exceed 50, more typically it does not exceed 45 and even more typically it does not exceed 40, weight percent of this overcoat formulation sans diluent and any other component of the overcoat formulation that evaporates or is other wise lost in the time period measured from the application of the overcoat formulation to the print media to the drying of the overcoat on the print media.

### Additives

Many types of additives, while not required, may be useful in the stain-resistant coating formulations. These additives may serve such functions as improving the wetting of the inkjet media surface, improving the flow and leveling of the stain-resistant coating, de-aeration to remove trapped air bubbles from the inkjet media and prevent the formation of pinholes in the coating, and UV stabilization of the stain resistant coating and the underlying layers of inks and coatings. Preferred additives include silicone and acetylenic flow and leveling agents from BYK Chemie, BASF, Crompton, and Dow Corning; de-aerators and de-foamers from BYK Chemie and Air Products; and UV absorbers and hindered amine stabilizers from Ciba Specialty Chemical. Particularly preferred UV absorbers include TINUVIN 384 triazine, TINUVIN 460 triazine, TINUVIN 477DF triazine, and TINUVIN 1130 benzotriazole.

For coatings that are to be applied by roll coating or Mayer rod coating, as opposed to application via an inkjet printhead, crosslinking agents may be added to improve the solvent resistance. Preferred crosslinking agents for hydroxyl-functional film-forming binder resins include Xama-2 and Xama-7 aziridines from BASF; CYMEL 385 melamine resin from Cytec; RESIMENE AQ 7550, RESIMENE 741, RESIMENE 745, and MAPRENAL MF 920 melamines from Cytec; BASONAT HW-100 waterborne isocyanurate from BASF; and BAYHYDUR 302 waterborne isocyanurate from Bayer.

The additives, if present, typically comprise at least 0.1, more typically at least 0.3 and even more typically at least 0.5, weight percent of the overcoat formulation sans diluent and any other component of the overcoat formulation that evaporates or is other wise lost in the time period measured from the application of the overcoat formulation to the print media to the drying of the overcoat on the print media. Typically, the total amount of additives in this overcoat formulation does not exceed 10, more typically it does not exceed 8 and even more typically it does not exceed 5, weight percent.

### Diluents

If the overcoat formulations of this invention are dispensed with inkjet printheads, typically a diluent is used to reduce the viscosity to a jettable range (<20 cP for some industrial printheads, as low as <6 cP for low-cost printheads designed for the home and office markets). Water is the most preferred diluent. However, it is also possible to use alcohols or other solvents that do not degrade the inkjet printheads, ink tanks or ink conduits of system. In many cases coalescents also contribute to the lowering of the formulation viscosity.

The diluent, if present and present in addition to a coalescent, typically comprises at least 20, more typically at least 30 and even more typically at least 40, weight percent of the overcoat formulation as constituted at the time the overcoat is applied to the print media. Typically, the diluent does not exceed 85, more typically it does not exceed 80 and even more typically it does not exceed 75, weight percent of the overcoat formulation as constituted at the time the overcoat is applied to the print media. If the diluent is present without a coalescent, then the diluent typically comprises at least 30, more typically at least 40, and even more typically at least 50, weight percent of the overcoat as constituted at the time the overcoat is applied to the print media. If the diluent is present without a coalescent, then typically the diluent does not exceed 90, more typically it does not exceed 85 and even more typically it does not exceed 80, weight percent of the overcoat as constituted at the time the overcoat is applied to the print media.

The invention is described more fully through the following examples.

### SPECIFIC EMBODIMENTS

### Examples 1-7

The components of the formulations for these examples are reported in Table 1. They were slowly added to a glass vessel and mixed with a magnetic stirrer for two hours. The properties of the binder resins used are shown in Table 2.

TABLE 1
Stain-Resistant Coating Examples - 100 Part Formulations

| Component | Ex. 1 | Ex. 2 | Ex. 3 | Ex. 4 | Ex. 5 | Ex. 6 | Ex. 7 |
|---|---|---|---|---|---|---|---|
| LUMIFLON FE- | 72.80 | 72.80 | 30.00 | 26.18 | 36.40 | | 4.00 |
| 4300 | | | | | | | |
| NEOCRYL A-634 | | | 42.80 | 36.76 | | 60.00 | 5.60 |
| JONCRYL 98 | | | | | 36.40 | | |
| WITCOBOND W- | | | | | | | 40.00 |
| 240 | | | | | | | |
| DOWANOL TPnB | | 7.20 | 7.20 | 7.06 | 7.20 | | |
| Ethanol | | | | | | | 28.00 |
| Deionized water | 27.20 | 19.80 | 20.00 | 29.40 | 20.00 | 40.00 | 22.40 |
| SILWET L-77 | | | | | | | |
| TINUVIN 477DW | | 0.20 | | | | | |
| TOTAL | 100.00 | 100.00 | 100.00 | 100.00 | 100.00 | 100.00 | 100.00 |
| % Polymer Solids | 36.4 | 36.4 | 30.0 | 26.0 | 35.3 | 21.0 | 16.0 |
| Viscosity (cP) | 16 | 20 | 21 | 11 | 36 | 5 | 50 |

LUMIFLON FE-4300 is a fluoroethylene-vinyl ether copolymer dispersion from Asahi Glass
NEOCRYL A-634 is an acrylic emulsion from DSM NeoResins
JONCRYL 98 is an acrylic emulsion from BASF
WITCOBOND W-240 is a polyurethane dispersion from Chemtura
DOWANOL TPnB is a tripropylene glycol n-butyl ether coalescent from Dow Chemical
SILWET L-77 is a silicone flow and leveling additive from Crompton
TINUVIN 477DW is a triazine UV absorber from Ciba Specialty Chemicals

TABLE 2
Properties of Binder Resin Dispersions Used in Formulation Examples

| | | | Minimum Film |
|---|---|---|---|
| | % | Viscosity | Formation |
| Binder Resin | Polymer | (cP) | Temperature (° C.) |
| LUMIFLON FE-4300 | 50.0 | 33 | 35 |
| fluoropolymer | | | |
| NEOCRYL A-634 acrylic | 35.0 | 200 | 0 |
| JONCRYL 98 acrylic | 47.0 | 500 | 5 |
| WITCOBOND W-240 | 30.0 | 150 | <0 |
| polyurethane | | | |

Test samples for the data of Table 3 were created according to the following procedure: Inkjet substrates were printed with color block test patterns or bar codes. After printing, the materials were allowed to dwell for 1-24 hours. Stain-resistant coating formulations were then drawn down over printed samples with Mayer rods and allowed to dry at ambient conditions. Other samples, which served as controls, had no stain-resistant coatings applied.

### Example 8

### Comparative

Some commercial printers offer clear fluids that can be applied to media via an inkjet printhead. The most common manifestation is the “gloss optimizer” fluid, which is employed to give both printed and unprinted areas of high-gloss media the same gloss level. An Epson R800 printer was set to apply the Gloss Optimizer clear fluid to the entire page, so as to provide data for a commercial system in which a clear overcoat is applied with some type of inkjet printhead.

### Test Methods and Grading of Samples

Reflected Optical Density of Prints

Color blocks of the primary (cyan, magenta, yellow, black) were printed at 100% ink laydown in Corel Draw 11. Color blocks of the secondary colors (red, green, blue), were also printed in this software application. When possible, for the different printers, color management was turned off to maximize the ink laydown. The reflected optical densities of the blocks were measured using a Gretag Macbeth D19C densitometer with ANSI Status T filters. For the primary colors, only a single density was measured. For the secondary colors, two densities were measured (magenta and yellow for red, cyan and yellow for green, cyan and magenta for blue). For each material, an overall average density for all seven colors was computed. The numerical averages were converted to grades according to the following scale: >1.30=A; 1.20-1.29=B; 1.10-1.19=C; 1.00-1.09=D; <1.00=F.

Stain Resistance

Printed blocks and white areas were both tested for stain resistance, as colored fluids can discolor printed blocks, but staining tends to be most severe in unprinted areas. Colored fluids were applied drop-wise with a pipette until a spot 10-15 mm in diameter was created. After the fluids were allowed to dwell for 60 minutes, the material was plunged into a bucket of water for 60 seconds, and subsequently removed and allowed to dry while hanging vertically. The performance was determined by measuring the difference in the L*, a*, and b* values of stained and unstained areas with a Hunter UltraScan XE Colorimeter. The instrument was set for a 10° observer, D65 illuminant, and reflected light with specular reflections included. The color difference, ΔE, was calculated according to Equation 1, where the subscript “0” denotes the initial value and the subscript “1” denotes the value at the end of the test.

ΔE=\sqrt{(L₁*−L₀*)²+(a₁*−a₀*)²+(b₁*−b₀*)²} Equation . . . 1
where:
   L*=Lightness
   a*=green−red . . . axis . . . value
   b*=blue−yellow . . . axis . . . value

Many tests were run with colored industrial fluids such as automotive brake fluid or Skydrol 500B-4 hydraulic fluid, but in many cases the power of these fluids as solvents makes it difficult to distinguish between the effects of salvation and staining. Because of this, the data presented here is strictly for waterborne fluids: unprinted and yellow patches were stained with coffee; unprinted and magenta areas were stained with Mountain Dew® Live Wire; and unprinted and cyan areas were stained with Gatorade® Fruit Punch. Stained samples were graded by the color difference, ΔE, between the stained and unstained samples. The average value for the six patches detailed above (unprinted−coffee, yellow−coffee . . . ) was employed as the metric according to this scale: ΔE<4.0=A; 4.0-8.0=B; 8.0-11.9=C; 12.0-15.9=D; ΔE>16.0=F.

Solvent Resistance

Printed blocks of primary and secondary colors were subjected to the following solvent dip and rub test: Four cycles of 10 minute immersion followed by 30 minute removal; one last cycle of 10 minute immersion, followed immediately by 10× double-rub test with cotton swab soaked in the solvent (double-rub=rub back and forth with light pressure applied to the swab). Thirteen solvents were tested: deionized water, isopropanol, methyl ethyl ketone, acetone, toluene, mineral spirits, gasoline, JP-8 jet fuel, brake fluid, SKYDROL 500B-4 hydraulic fluid, SAE 20 wt oil, 3% aqueous Alconox solution, and a 10% sulfuric acid solution. For each of the solvents, the amount of damage to the printed image was graded as one of the following: no visible effect (3 points), slight effect (2 points), moderate effect (1 point), or severe effect (0 points). The grades for the thirteen solvents were added up and averaged. As a metric, these numerical averages were converted to grades according to the following scale: >2.24=A; 2.00-2.24=B; 1.75-1.99=C; 1.50-1.74=D; <1.50=F.

Accelerated Weathering

Color blocks of the primary (cyan, magenta, yellow, black) were printed at 100% ink laydown in Corel Draw 11. Color blocks of the secondary colors (red, green, blue), were also printed in this software application. When possible, for the different printers, color management was turned off to maximize the ink laydown. The reflected optical densities of the blocks were measured using a Gretag Macbeth D19C densitometer with ANSI Status T filters. For the primary colors, only a single density was measured. For the secondary colors, two densities were measured (magenta and yellow for red, cyan and yellow for green, cyan and magenta for blue). For each material, an overall average density for all seven colors was computed. Samples with printed color blocks were placed in an Atlas Ci5000 Xenon Arc Weather-Ometer and tested using ASTM G155, Cycle 1. The reflected optical densities of the color blocks samples were monitored for 800 hr, which is believed to be approximately equivalent to one year outdoors in Milwaukee, Wis., USA (Reference: B. Klemann, “Correlations between Xenon Arc accelerated weathering tests and Outdoor Weathering”, IS&T NIP 19 International Conference on Digital Printing Technologies, 396, 2003.) For each color, the ratios of the average reflected optical density after 800 hr and 1600 hr to the initial reflected optical density were calculated. For both time periods, the averages were graded according to the following scale: >0.849=A; 0.700-0.849=B; 0.550-0.649=C; 0.400-0.549=D; <0.400=F.

Abrasion Resistance

A black patch 10 cm×10 cm in size was printed at 100% ink laydown. The patch of printed media was then mounted on an aluminum plate and tested on a Taber Abraser, using a CS-10 abrasive wheel with 500 g weights hung from the two arms attached to the abrasive wheels. The black reflected optical density was measured periodically at eight points around the circular patch that was ground into the media with the abrasive wheels. The test was terminated when the average black reflected optical density of the eight points was reduced to 70% of the initial average black reflected optical density. The number of cycles to the endpoint was graded according to the following scale: >500=A; 250-499=B; 100-249=C; 50-99=D; <50=F.

### Results and Discussion

Table 3 provides an overview of the test results for Examples 1-8 when used with several printers. The results illustrate the benefits of this invention and show the decrease in performance that occurs when the coating is not formulated properly. Materials 1 and 2 are multilayer inkjet media. Material 3 is an example of single-layer inkjet media that is representative of U.S. Pat. No. 5,882,388. Materials 1 through 5 are all of the class of microporous, as opposed to swellable, aqueous inkjet media. The wide-format and photo media samples were chosen to represent several of the best-in-class, commercially-available products.

TABLE 3
Stain-Resistant Coating Test Results

| | | | | Grade - | Grade - | Grade - | Grade - | Grade - |
|---|---|---|---|---|---|---|---|---|
| | | Mayer | | Optical | Stain | Solvent | 800 hr | 1600 hr |
| Substrate | Overcoat | Rod# | Printer | Density | Resistance | Resistance | Weathering | Weathering |
| Material 1 | None | — | Epson | B | C | A | C | F |
| | | | C88+ | | | | | |
| Material 1 | Ex. 4 | 12 | Epson | A | A | A | B | B |
| | | | C88+ | | | | | |
| Material 1 | Ex. 4 | 12 | Epson PX- | A | A | A | A | A |
| | | | 6250S | | | | | |
| Material 2 | None | — | Epson | C | F | A | B | D |
| | | | C88+ | | | | | |
| Material 2 | Ex. 1 | 12 | Epson | C | F | A | B | C |
| | | | C88+ | | | | | |
| Material 2 | Ex. 2 | 12 | Epson | A | A | A | B | B |
| | | | C88+ | | | | | |
| Material 2 | Ex.3 | 6 | Epson | C | A | A | A | A |
| | | | C88+ | | | | | |
| Material 2 | Ex. 4 | 12 | Epson | C | A | A | A | A |
| | | | C88+ | | | | | |
| Material 2 | Ex. 4 | 16 | Epson | C | A | A | A | A |
| | | | C88+ | | | | | |
| Material 2 | Ex. 4 | 20 | Epson | B | A | A | A | B |
| | | | C88+ | | | | | |
| Material 2 | Ex. 4 | 4 | Epson | D | B | A | A | A |
| | | | C88+ | | | | | |
| Material 2 | Ex. 4 | 8 | Epson | D | A | A | A | A |
| | | | C88+ | | | | | |
| Material 2 | Ex. 4 | 12 | Epson PX- | B | A | A | A | A |
| | | | 6250S | | | | | |
| Material 2 | Ex. 4 | 12 | Lexmark | B | A | A | A | B |
| | | | X9350 | | | | | |
| Material 2 | Ex. 5 | 12 | Epson | A | A | A | B | B |
| | | | C88+ | | | | | |
| Material 2 | Ex. 6 | 12 | Epson | B | D | A | A | B |
| | | | C88+ | | | | | |
| Material 2 | Ex. 7 | 12 | Epson | C | D | A | A | B |
| | | | C88+ | | | | | |
| Material 2 | Competitive | — | Epson | F | F | A | B | D |
| | Ex. 8 | | R800 | | | | | |
| Material 3 | None | — | Epson | C | F | A | B | F |
| | | | C88+ | | | | | |
| Material 3 | Ex. 4 | 12 | Epson | C | A | A | A | A |
| | | | C88+ | | | | | |
| Material 3 | Ex. 4 | 12 | Lexmark | D | A | A | A | A |
| | | | X9350 | | | | | |
| Material 4 | None | — | Epson | D | F | A | F | F |
| | | | C88+ | | | | | |
| Material 4 | Ex. 3 | 6 | Epson | C | A | A | B | C |
| | | | C88+ | | | | | |
| Material 5 | None | — | Epson | A | F | D | C | F |
| | | | C88+ | | | | | |
| Material 5 | Ex. 4 | 12 | Epson | A | A | A | A | B |
| | | | C88+ | | | | | |
| Material 5 | Competitive | 12 | Epson | C | F | B | F | F |
| | Ex. 8 | | R800 | | | | | |
| W. F. | None | — | Epson | A | F | A | C | F |
| Media A | | | C88+ | | | | | |
| W. F. | Ex. 2 | 12 | Epson | A | A | A | A | B |
| Media A | | | C88+ | | | | | |
| W. F. | Ex. 4 | 12 | Epson | A | A | A | A | A |
| Media A | | | C88+ | | | | | |
| W. F. | Ex. 4 | 12 | Lexmark | A | A | A | A | B |
| Media A | | | X9350 | | | | | |
| W. F. | Ex. 5 | 12 | Epson | A | A | A | A | B |
| Media A | | | C88+ | | | | | |
| W. F. | Ex. 7 | 12 | Epson | A | D | A | A | C |
| Media A | | | C88+ | | | | | |
| W. F. | Competitive | — | Epson | C | F | B | C | F |
| Media A | Ex. 8 | | R800 | | | | | |
| W. F. | None | — | Epson | A | F | A | F | F |
| Media B | | | C88+ | | | | | |
| W. F. | Ex. 4 | 12 | Epson | A | A | A | B | C |
| Media B | | | C88+ | | | | | |
| W. F. | None | — | Epson | A | D | A | B | C |
| Media B | | | C88+ | | | | | |
| W. F. | Ex. 4 | 12 | Epson | A | A | A | A | A |
| Media B | | | C88+ | | | | | |
| Photo | None | — | Epson | A | F | D | F | F |
| Media D | | | C88+ | | | | | |
| Photo | Ex. 4 | 12 | Epson | A | A | C | C | F |
| Media D | | | C88+ | | | | | |
| Photo | Competitive | — | Epson | A | D | F | F | F |
| Media D | Ex. 8 | | R800 | | | | | |
| Photo | None | — | Epson | A | F | F | F | F |
| Media E | | | C88+ | | | | | |
| Photo | Ex. 4 | 12 | Epson | A | A | B | F | F |
| Media E | | | C88+ | | | | | |
| Photo | None | — | Epson | A | F | F | F | F |
| Media F | | | C88+ | | | | | |
| Photo | Ex. 4 | 12 | Epson | A | A | C | B | D |
| Media F | | | C88+ | | | | | |

The Example 1 formulation contains a dispersion of a fluoropolymer for which the minimum film forming temperature (MFFT) is 35° C., but no coalescent. Since the MFFT is above ambient conditions, it does not form a continuous, coherent film when it is dried at ambient. Since the film has holes, the stain resistance is poor, although weathering performance does improve. FE-4300+water (no coalescent) gives poor stain resistance because it does not form a coherent film, but it does improve weathering.

Example 2 is identical to Example 1 except for the addition of coalescent tripropylene glycol n-butyl ether. The coalescent reduces the MFFT so that a continuous film is formed. This results in good stain resistance and solvent resistance when the coat weight is high (#6 rod or larger). For thinner coatings, a second binder resin is typically used to promote film forming.

Example 3 shows the effect of adding an excellent film-former, NEOCRYL A-634 acrylic dispersion, to the formulation. Application via drawdowns or roll coating results in strong, coherent, protective films. For many material/printer combinations, including wide-format media vendors, A grades across the board for stain resistance, solvent resistance, and weathering can be achieved. The only limitation is that the viscosity of 21 cP is too high for application with inkjet printheads.

The formulation of Example 4 is identical to that of Example 3, except that more water has been added to reduce the viscosity to 11 cP for compatibility with piezoelectric inkjet printheads. Excellent results were obtained in application trials with piezoelectric inkjet nozzles. All of the performance benefits of Example 3 are retained: The stain resistance is excellent for all inkjet media, and the solvent resistance and weathering are very good for all materials and all types of wide-format inkjet media.

Example 5 is another example where the addition of a strongly film-forming binder resin, JONCRYL 98, has been added to strengthen the protective films. This formulation also performs well for stain resistance, solvent resistance, and weathering. Application via drawdowns or roll coating results in strong, coherent, protective films. However, the viscosity is too high for application with the inkjet printheads.

Example 6 illustrates the effects of using only a strong film-forming resin without the fluoropolymer resin. Solvent resistance and weathering performance is good, but the protective film is higher in surface energy than those of Examples 1-5, so liquids are more able to penetrate any pores that are not fully sealed. The result is a decrease in stain-resistance, with a D grade rather than an A grade.

Example 7 illustrates the effects of using too low of a concentration of the fluoropolymer in the formulation. In this formulation, the fluoropolymer is 12.5% by weight of the total binder resins, and the two systems on Table 3 with this clear coat both have D grades for solvent resistance. At least 20% by weight of fluoropolymer in the binder resins is necessary to achieve a B grade or better in the stain resistance test.

The use of a “gloss optimizer” in Comparative Example 8 does not significantly improve stain resistance, solvent resistance, or weathering performance of the inkjet materials tested. Indeed this fluid was not developed to improve these properties, but was designed to equalize the gloss level between printed and unprinted areas of glossy photo media. The formulation has decent water resistance, but offers little protection from solvents or weathering.

In addition to the Mayer rod drawdowns, coatings were also tested for compatibility with a piezoelectric inkjet printhead (based upon U.S. Pat. No. 6,460,980). The printheads were used to achieve applied coat weights of 2-15 g/m². The appropriate viscosity range for the stain-resistant fluids was 5-15 cP. When the fluids are in this viscosity range, the inkjet printheads can be used to apply a uniform layer of droplets that coalesced into a continuous, stain-resistant coating.

### Forced Drying Examples

Several examples were performed to determine whether forced drying can be used to reduce the drying time of the coatings to ten seconds or less, which would be appropriate for use in a printing system. Data for the formulation of Example 3 is presented in Table 4. As seen from this data, the drying time increases rapidly with increasing coat weight, but for a #8 rod and smaller rods it is possible to dry the coating within 10 seconds.

TABLE 4
Drying Experiments with Example 3 Formulation

| | Coat | | Distance from | |
|---|---|---|---|---|
| | Weight | Heated Air | Air Nozzle to | Drying |
| Mayer Rod # | (g/m²) | Applied | Substrate (ft) | Time (s) |
| 3 | 2.3 | No | — | 4 |
| 4 | 3.0 | No | — | 22 |
| 4 | 3.0 | Yes | 3 | 13 |
| 4 | 3.0 | Yes | 1 | 8 |
| 8 | 6.1 | No | — | 135 |
| 8 | 6.1 | Yes | 1 | 10 |
| 16 | 12.2 | Yes | 1 | 30 |

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. A stain-resistant, overcoat formulation for porous print media and having a viscosity of less than 20 cP, the overcoat formulation comprising at least one (a) low-surface-energy fluoropolymer, and (b) film-forming binder resin.

2. The overcoat formulation of claim 1 in which the fluoropolymer and binder resin are present in the overcoat formulation at a fluoropolymer to binder resin weight ratio of 0.25:1 to 9:1.

3. The overcoat formulation of claim 2 in which the fluoropolymer comprises at least 12 weight percent of the overcoat formulation sans any diluent.

4. The overcoat formulation of claim 3 in which the film-forming polymer comprises at least 10 percent by weight of the overcoat formulation sans any diluent.

5. The overcoat formulation of claim 4 in which the fluoropolymer is at least one of poly(tetrafluoroethylene), poly(vinyl fluoride), poly(vinylidene fluoride), poly(hexafluoro-propylene), fluorinated ethylene-propylene copolymers, copolymers of hexafluoropropylene and vinyl fluoride, terpolymers of hexafluoropropylene-vinyl fluoride-tetrafluoroethylene, polymers of mixed fluoro-chloro ethylenes and propylenes, copolymers of tetrafluoroethylene and vinylidene fluoride, and polymers of perfluoroalkyoxy resins.

6. The overcoat formulation of claim 5 in which the binder resin is at least one of an acrylic or methacrylic, polyurethane, polyester, polycarbonate, poly(vinyl ether), poly(vinyl acetate), poly(vinyl alcohol), poly(vinyl butyral), a copolymer of vinyl acetate and vinyl alcohol, a thermoplastic polymer of ethylene and/or propylene, poly(vinyl chloride), polyamide, polyimide, a styrenic resin, phenoxies, a cellulose acetate butyrate polymer, a cellulose acetate propionate polymer and an ionomer.

7. The overcoat formulation of claim 6 further comprising a coalescent.

8. The overcoat formulation of claim 7 in which the coalescent is at least one of glycol ether and glycol ether acetate.

9. The overcoat formulation of claim 8 further comprising an additive.

10. The overcoat formulation of claim 9 in which the additive is at least one of a silicone or acetylenic flow or leveling agent, de-aerator or de-foamer, and UV absorber or hindered amine stabilizer.

11. The overcoat formulation of claim 9 further comprising a diluent.

12. The overcoat formulation of claim 11 in which the diluent is water.

13. A label or sign incorporating the overcoat formulation of claim 1.

14. The label or sign of claim 13 in which the overcoat formulation is applied to the print media with an inkjet printhead.

15. A method of applying a stain-resistant overcoat to porous printed media, the method comprising the step of depositing the overcoat to the printed media using an inkjet printhead.
